(19) United States
(12) Patent Application Publication
(10) Pub. No.: US 2024/0429555 A1
(43) Pub. Date: Dec. 26, 2024

(54) COPOLYMER FOR SEPARATOR, AND SECONDARY BATTERY COMPRISING SAME

(71) Applicant: Hansol Chemical Co., Ltd, Seoul (KR)

(72) Inventors: Go-Eun Lee, Wanju-gun, Jeollabuk-do (KR); Bo-Ok Jang, Wanju-gun, Jeollabuk-do (KR); Jin-Yeong Kim, Wanju-gun, Jeollabuk-do (KR); Seung-Heon Kim, Wanju-gun, Jeollabuk-do (KR); Jun Park, Wanju-gun, Jeollabuk-do (KR); Sae-Wook Oh, Wanju-gun, Jeollabuk-do (KR); Se-Man Kwon, Wanju-gun, Jeollabuk-do (KR)

(21) Appl. No.: 18/684,821

(22) PCT Filed: Sep. 30, 2021
(86) PCT No.: PCT/KR2021/013434

§ 371 Date: Feb. 19, 2024

(30) Foreign Application Priority Data
Sep. 29, 2021 (KR) 10-2021-0128913

(51) Int. Cl. H01M 50/42; C08F 216/06; C08K 5/17; H01M 50/446

(52) U.S. Cl. CPC H01M 50/42; C08F 216/06; C08K 5/17; H01M 50/446; C08F 2800/20

(57) ABSTRACT

The present invention relates to a copolymer, a slurry composition using same, a separator, and a secondary battery, the copolymer comprising, relative to 100 weight % of the total weight of the copolymer: 3 weight % to 38 weight % of vinyl acetate-based monomer unit; 57 weight % to 81 weight % of vinyl alcohol-based monomer unit; 0.7 weight % to 18 weight % of acrylate-based monomer unit; 14 weight % to 38 weight % of acrylic acid-based monomer unit; and less than 1 weight % of amine organic compound.

### TECHNICAL FIELD

The present disclosure relates to a copolymer, a slurry composition using the same, a separator, and a secondary battery.

### BACKGROUND ART

With high energy density, lithium secondary batteries are being used extensively in electrical, electronic, telecommunication, and computer industries. Additionally, application fields of lithium secondary batteries are being expanded to high-capacity secondary batteries for hybrid vehicles, electric vehicles, and the like, in addition to small lithium secondary batteries for portable electronic devices.

Although the insulation of lithium-ion secondary batteries is enabled by separators, internal or external battery abnormalities, or shocks cause a short circuit between positive and negative electrodes, which may lead to heat generation and explosion. Thus, ensuring the thermal and chemical safety of the separator is extremely important.

Currently, polyolefin-based films are being used widely as separators, but polyolefins have the disadvantages of severe heat shrinkage at high temperatures and poor mechanical properties.

To improve the stability of such polyolefin-based separators, a porous separator in which a polyolefin porous substrate film is coated with a mixture of inorganic particles and a binder has been developed.

That is, to suppress battery instability due to dendrite and heat shrinkage of polyolefin-based separators caused by high temperatures, one or both sides of the porous separator substrate are coated with the inorganic particles also in combination with the binder. Accordingly, the inorganic particles can provide the function of suppressing the shrinkage rate of the substrate. At the same time, a further safe separator can be manufactured by the coating layer.

To obtain excellent battery characteristics, the coating layer is required not only to be evenly coated but also to have strong adhesive strength to the substrate.

Additionally, to cope with the recent high capacity and high output of batteries, the heat resistance of existing separators needs to be further improved.

### DOCUMENT OF RELATED ART

### Patent Document

(Patent Document 2) Korean Patent No. 10-1430975
(Patent Document 1) Korean Patent Application Publication No. 10-2006-0072065

### DISCLOSURE

### Technical Problem

Accordingly, the present disclosure aims to provide a copolymer capable of increasing the dispersion stability of a slurry composition.

Additionally, the present disclosure aims to provide a slurry composition having excellent adhesive strength with the use of the copolymer.

Furthermore, the present disclosure aims to provide a separator having excellent heat resistance by applying the slurry composition and a battery having excellent performance with the use of the separator.

However, the problems to be solved by the present disclosure are not limited to the above description, and other problems can be clearly understood by those skilled in the art from the following description.

### Technical Solution

In a first aspect of the present application, a copolymer including a vinyl acetate-based monomer unit in an amount of 3 wt % or greater and 38 wt % or less, a vinyl alcohol-based monomer unit in an amount of 57 wt % or greater and 81 wt % or less, an acrylate-based monomer unit in an amount of 0.7 wt % or greater and 18 wt % or less, an acrylic acid-based monomer unit in an amount of 14 wt % or greater and 38 wt % or less, and

an amine-based organic compound in an amount of less than 1 wt %, based on 100 wt % of the total weight of the copolymer,

is provided.

In a second aspect of the present application, a slurry composition including the copolymer and

inorganic particles

is provided.

In a third aspect of the present application, a separator containing the slurry composition

is provided.

In a fourth aspect of the present application, a secondary battery including the separator

is provided.

### Advantageous Effects

A copolymer of the present disclosure can improve the dispersion stability of a slurry composition, increase adhesive strength to a polyolefin film, which is a separator substrate, and improve the heat resistance of a separator.

### BEST MODE

Hereinafter, the action and effect of the present disclosure will be described in detail through specific embodiments of the disclosure. However, these embodiments are provided only for illustrative purposes, and the scope of the present disclosure is not limited to the following embodiments.

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Therefore, the configuration of embodiments described herein are merely examples and do not exhaustively present the technical spirit of the present disclosure. Accordingly, it should be appreciated that there may be various equivalents and modifications that can replace the embodiments and the configurations at the time at which the present disclosure is filed.

As used herein, the singular forms are intended to include the plural forms as well, unless the context clearly indicates otherwise. It will be further understood that the terms “comprise”, “include”, “have”, etc. when used herein, specify the presence of stated features, integers, steps, components, or combinations thereof but do not preclude the presence or addition of one or more other features, integers, steps, components, or combinations thereof.

As used herein to represent a specific numerical range, the expression “a to b” means “≥a and ≤b”.

A copolymer, according to a first aspect of the present application, may include: a vinyl acetate-based monomer unit in an amount of 3 wt % or greater and 38 wt % or less; a vinyl alcohol-based monomer unit in an amount of 57 wt % or greater and 81 wt % or less; an acrylate-based monomer unit in an amount of 0.7 wt % or greater and 18 wt % or less; an acrylic acid-based monomer unit in an amount of 14 wt % or greater and 38 wt % or less; and an amine-based organic compound in an amount of less than 1 wt %, based on 100 wt % of the total weight of the copolymer.

The copolymer is prepared through copolymerization of the vinyl acetate and acrylate monomers, alkaline hydrolysis, and reaction with the amine-based organic compound.

The hydrolysis causes a part of the vinyl acetate-based monomer unit to be converted into the vinyl alcohol-based monomer unit and a part of the acrylate-based monomer unit to be converted into the acrylic acid-based monomer unit.

The degree of such hydrolysis may be adjusted to, for example, 70% or greater, 75% or greater, 80% or greater, 85% or greater, 90% or greater, or 95% or greater.

When the content of the monomer unit does not fall within the above numerical range, one or more among the dispersion stability of a slurry composition to which the copolymer is applied, the adhesive strength of a coating film, and the heat resistance of a separator may be poor.

The amine-based organic compound may be configured to decrease the glass transition temperature (Tg) of the copolymer and cause softening.

This is because a terminal, being ionized by metal, of the acrylic acid-based monomer units of the copolymer is substituted with the amine-based organic compound to form ionic bonds, and the aggregation properties of the chains of the copolymer are improved by the action of electrostatic repulsion or the large volume of such a bonded amine-based organic compound.

As the chains unfold rather than aggregate, the glass transition temperature of the copolymer may be decreased.

The effect of the amine-based organic compound in decreasing the glass transition temperature and softening the chains may improve the effect of physically bonding the slurry composition containing the copolymer to the inorganic separator substrate.

Additionally, the strong ionic bonding and physical cross-linking caused by the amine-based organic compound may alleviate the heat shrinkage of the separator, which may also affect the solubility in water.

In other words, the higher the content of the amine-based organic compound, the higher the water content of the copolymer, but the lower the solubility in water.

When the content of the amine-based organic compound is 1 wt % or greater based on 100 wt % of the total weight of the copolymer, the heat resistance of the separator manufactured using the copolymer may be poor.

Additionally, the content of the amine-based organic compound is, preferably, 0.1 wt % or greater and, more preferably, 0.2 wt % or greater, based on 100 wt % of the total weight of the copolymer.

In one example, the copolymer may be represented by Formula 1 below.

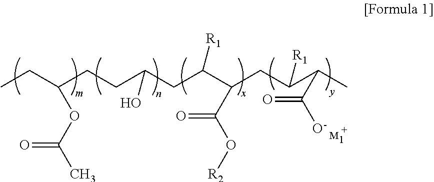

In Formula 1,
R₁ may be hydrogen or a straight-chain or branched-chain hydrocarbon having 1 to 4 carbon atoms,
each R₂ may be hydrogen or a straight-chain or branched-chain hydrocarbon having 1 to 20 carbon atoms,
M₁ may include one or more selected from the group consisting of secondary and tertiary amines, and
m, n, x, and y may satisfy m+n+x+y=1.

In Formula 1, m, n, x, and y correspond to the mole fractions of the respective monomer units, and the sum of the mole fractions of the respective monomer units is 1.

The acrylic acid-based monomer unit of the copolymer may have a form in which the end group thereof is ionically bonded to one or more selected from the group consisting of secondary and tertiary amines.

In one example, R₁ in Formula 1 may include one or more selected from the group consisting of hydrogen, methyl, and ethyl.

Additionally, R₂ in Formula 1 may include one or more selected from the group consisting of methyl, ethyl, n-propyl, isopropyl, n-butyl, tert-butyl, n-pentyl, n-hexyl, n-heptyl, n-octyl, 2-ethylhexyl, n-nonyl, n-decyl, n-undecyl, lauryl, n-dodecyl, n-tridecyl, n-tetradecyl, n-pentadecyl, cetyl, n-hexadecyl, n-heptadecyl, stearyl, n-octadecyl, n-nonadecyl, n-icosyl, n-henicosyl, n-docosyl, isopentyl, isoheptyl, isooctyl, isononyl, isodecyl, isoundecyl, isododecyl, isotridecyl, isotetradecyl, isopentadecyl, isocetyl, isohexadecyl, isoheptadecyl, isostearyl, isooctadecyl, isononadecyl, isoicosyl, isohenicosyl, and isodocosyl.

In one example, M₁ in Formula 1 may include one or more compounds selected from the group consisting of compounds of Formulas 2 to 5 below.

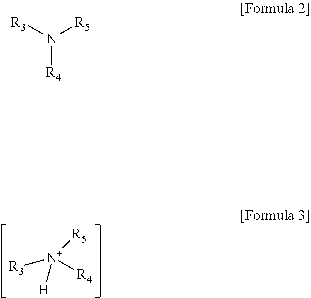

In Formulas 2 and 3, R₃ to R₅ may each independently be a straight-chain or branched-chain hydrocarbon having 1 to 6 carbon atoms.

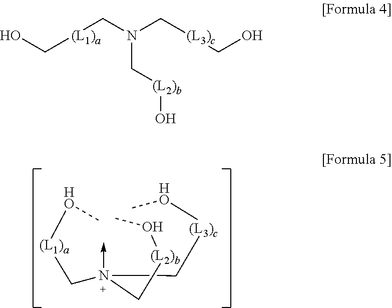

In Formulas 4 and 5, L₁ to L₃ may each independently be an alkylene group having 1 to 6 carbon atoms, and a to c may each independently be an integer of 0 to 2.

In one example, the copolymer may be a random or block copolymer depending on a synthesis process.

In one example, the copolymer may have a number average molecular weight in a range of 5,000 to 1,000,000.

When the number average molecular weight of the copolymer is less than 5,000, the fluidity of the copolymer may increase, thus deteriorating the dispersibility and the heat resistance properties of the separator. When the number average molecular weight is 1,000,000 or greater, the viscosity may be excessively high to be used, and the pores of the separator may be blocked, thus reducing air permeability and resistance.

In one example, m, n, x, and y in Formula 1 may satisfy the following expressions: 1.5≤(m+n)/(x+y)≤5.5, 0.05≤m/n≤0.45, and 0.05≤x/y≤0.45.

The ratio of the monomers in the copolymer may be adjusted by varying the contents of the vinyl acetate and acrylic monomers, which are reaction starting materials, and the degree of hydrolysis.

When (m+n)/(x+y) of the copolymer exceeds 5.5, the dispersion force of the copolymer may decrease. When (m+n)/(x+y) is less than 1.5, the dispersion force of the copolymer may decrease while the heat resistance of the separator, to which the copolymer is applied, may be poor.

When the degree of hydrolysis is adjusted to allow m/n and/or x/y of the copolymer to be less than 0.05, the hydrophobicity of the copolymer is improved, thus increasing the adhesive strength to the substrate. However, the dispersibility of the slurry composition containing inorganic particles and the copolymer is significantly deteriorated, which is undesirable.

Additionally, when the degree of hydrolysis is adjusted to allow m/n and/or x/y of the copolymer to exceed 0.45, the hydrophobicity of the copolymer is poor, thus significantly reducing the adhesive strength to the substrate.

A slurry composition, according to a second aspect of the present application, may include the copolymer and inorganic particles.

The slurry composition may have an adhesive strength of 80 gf/mm or higher.

The inorganic particles may be used without limitation as long as the particles are insulator particles, and are preferably high dielectric constant insulator particles.

Specific examples of the inorganic particles may include Al₂O₃, SiO₂, TiO₂, ZrO₂, ZnO, NiO, CaO, SnO₂, Y₂O₃, MgO, BaTiO₃, CaTiO₃, SrTiO₃, SiC, Li₃PO₄, Pb (Zr,Ti)O₃(PZT), (Pb,La)(Zr,Ti) O₃(PLZT), and mixtures thereof.

The inorganic particles are not particularly limited in size, but the median particle diameter thereof may be, for example, in a range of 0.01 to 30 μm and is, more preferably, in the range of 0.1 m to 10 μm. When the median particle diameter of the inorganic particles is smaller than the above preferable range, dispersibility may be poor. When the median particle diameter exceeds the above preferable range, the thickness of the coating layer may be increased after coating, thus deteriorating mechanical properties.

Additionally, the inorganic particles are not particularly limited in form but may have, for example, a spherical, elliptical, or irregular form.

A separator, according to a third aspect of the present application, may include the slurry composition.

The separator may have a heat shrinkage rate of 5% or lower in both a machine direction (MD, longitudinal direction) and a transverse direction (TD, width direction).

The separator may be manufactured by coating at least one side of a porous substrate film with the slurry composition described above, or by forming the slurry composition into a film form and laminating such a formed film to the porous substrate film.

On the other hand, the separator may be used as a separator for a secondary battery, for example, a separator for a lithium secondary battery.

One example of manufacturing the separator may include: (a) preparing a polymer solution by dissolving the copolymer in a solvent, (b) obtaining a mixture by adding and mixing the inorganic particles to the polymer solution in the a) preparing, and (c) coating and drying one or more regions selected from the group consisting of the surface of a polyolefin-based separator substrate and some of pores in the substrate with the mixture of the b) obtaining.

First, 1) a polymer solution is prepared by dissolving the copolymer in an appropriate organic solvent.

Preferably, the solvent has a solubility index not inferior to that of the copolymer, used as a binder, and has a low boiling point, which is to facilitate the mixing to be uniform and the solvent to be easily removed later. Non-limiting examples of the available solvents may include acetone, tetrahydrofuran, methylene chloride, chloroform, dimethylformamide, N-methyl-2-pyrrolidone (NMP), cyclohexane, water, or mixtures thereof.

2) The mixture of the inorganic particles and the polymer is prepared by adding and dispersing the inorganic particles to the prepared polymer solution.

After adding the inorganic particles to the polymer solution, a process of dispersing the inorganic particles is preferably performed. In this case, the dispersion may be appropriately performed for 1 to 20 hours. An existing method may be used as a dispersion method, and particularly, a ball milling method is preferable.

The mixture composed of the inorganic particles and the polymer is not particularly limited in composition. However, depending on the composition of the mixture, the thickness, pore size, and porosity of the finally manufactured organic/inorganic composite porous separator of the present disclosure may be controlled.

In other words, the higher the ratio (ratio=I/P) of the inorganic particles (I) to the polymer (P), the higher the porosity of the separator, resulting in an increase in thickness of the separator under the same amount of non-volatile phase (inorganic particle weight plus polymer weight). Additionally, pores are more likely to be formed between the inorganic particles, so the pore size is larger. In this case, the larger the size (particle diameter) of the inorganic particles, the greater the interstitial distance between the inorganic particles, thus increasing the pore size.

3) The manufactured polyolefin-based separator substrate is coated with the prepared mixture of the inorganic particles and the polymer and then dried, thereby obtaining the separator of the present disclosure.

In this case, an existing coating method known in the art may be used as a method of coating the polyolefin-based separator substrate with the mixture of the inorganic particles and the polymer. For example, various methods, such as dip coating, die coating, roll coating, comma coating, or combinations of these methods, may be used. Additionally, when coating the polyolefin-based separator substrate with the mixture of the inorganic particles and the polymer, the coating may be performed on both sides of the separator substrate or selectively performed on only one side.

When using the separator in a secondary battery, lithium ions may be transferred not only through the separator substrate but also through a porous active layer, not to mention that the safety improvement effect described above may be exhibited when an external impact causes internal short circuits.

Additionally, the secondary battery may include a positive electrode, a negative electrode, the separator interposed between the positive and negative electrodes, and an electrolyte solution.

The secondary battery may be manufactured by existing methods known in the art. For example, the secondary battery is manufactured by interposing the separator between the electrodes to obtain an assembly and then injecting the electrolyte solution into the assembly.

The electrodes to be used in combination with the separator are not particularly limited. However, typical positive electrode active materials available for positive electrodes of secondary batteries may be used as a positive electrode active material. Non-limiting examples thereof may include lithium intercalation material, such as lithium manganese oxide (lithiated magnesium oxide), lithium cobalt oxide (lithiated cobalt oxide), a lithium nickel oxide (lithiated nickel oxide), or a composite oxide formed by combinations thereof. Additionally, typical negative electrode active materials available for negative electrodes of existing electrochemical devices may be used as a negative electrode active material. Non-limiting examples thereof may include lithium intercalation material, such as lithium metal, lithium alloys, carbon, petroleum coke, activated carbon, graphite, or other carbon-based materials. Both the electrodes are configured in such forms that the respective electrode active materials, described above, are bound to a positive electrode current collector, that is, a foil made of aluminum, nickel, or combinations thereof, and a negative electrode current collector, that is, a foil made of copper, gold, nickel, copper alloys, or combinations thereof, respectively.

The electrolyte solution preferably has a form in which a salt having a structure such as A+B−, where A+ includes an alkali metal cation such as Li⁺, Na⁺, and K⁺, or an ion composed of combinations thereof, and B− includes an anion such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, and C(CF₂SO₂)₃⁻, or an ion composed of combinations thereof, is dissolved and dissociated in an organic solvent composed of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethyl methyl carbonate (EMC), gamma-butyrolactone (GBL), or a mixture thereof.

In addition to typical winding processes, a process of laminating and folding the separator and the electrodes is usable as a process of applying the separator to a battery.

### MODE FOR INVENTION

Hereinafter, the present application will be described in more detail using examples, but the present application is not limited thereto.

### [Preparation Example 1] Preparation of Copolymer

Distilled water in an amount of 200 parts by weight and an emulsifier in an amount of 0.1 to 3 parts by weight with respect to 100 parts by weight of a monomer mixture (vinyl acetate-based and (meth) acrylate-based monomers) were added to a reaction vessel, stirred, and heated to a temperature of 60° C. while injecting high-purity nitrogen gas thereinto. The monomer mixture and potassium persulfate, a degradable initiator, in an amount of 0.1 to 0.5 parts by weight with respect to the monomer mixture in an amount of 100 parts by weight were each independently added to the reaction vessel prepared at a temperature of 60° C. to perform continuous emulsion polymerization, thereby preparing vinyl acetate-based and (meth)acrylate-based copolymers.

The copolymers prepared through the emulsion polymerization were heated to a temperature of 60° C. in an alcohol solvent in an amount of 2 to 5 times the weight thereof for expansion or dissolution. The copolymers were synthesized by adding an aqueous solution of metal hydroxides (NaOH, LiOH, and KOH) and allowing hydrolysis to occur.

An amine-based organic compound was added to the copolymers and reacted to prepare a binder copolymer.

### [Preparation Example 2] Preparation of Porous Film-Coating Slurry

Inorganic particles (alumina having a median particle diameter of 0.5 μm) and the binder copolymer prepared by Preparation Example 1 were mixed to a ratio (non-volatile phase weight ratio) of 96:4. Then, distilled water was added and mixed to a non-volatile phase concentration of 35%. The resulting mixture was sufficiently dispersed using a ball milling method or mechanical stirrer, thereby preparing a porous film-coating slurry.

### [Preparation Example 3] Manufacturing of Separator

A polyolefin porous substrate (polyethylene (PE), polypropylene (PP), and the like) was coated with the porous film-coating slurry prepared by Preparation Example 2 to form an inorganic coating layer. Various methods, such as dip coating, die coating, gravure coating, comma coating, and the like, were available as a coating method.

Additionally, methods, including warm air drying, hot air drying, vacuum drying, infrared drying, and the like, were used for drying after the coating, where the drying temperature was in a range of 60° C. to 85° C.

The inorganic coating layer formed on one or both sides had a thickness in a range of 1 to 6 μm. When the thickness was smaller than 1 μm, there was a problem in that the heat resistance of the separator was significantly poor. When the thickness exceeded 6 μm, the thickness of the separator was excessively large, resulting in a decrease in battery energy density and an increase in battery resistance.

### Examples 1 to 5 and Comparative Examples 1 to 7

Binder copolymers of Examples 1 to 5 were prepared according to Preparation Example 1 by adjusting the composition ratio of the monomers, degree of hydrolysis, and content of the amine-based organic compound, as shown in Table 1 below.

Vinyl acetate (VC) and methyl methacrylate (MMA) were used as the monomers, and triethanol amine (TA) was used as the amine-based organic compound.

Using the binder copolymers prepared by Examples 1 to 5 and Comparative Examples 1 to 7, porous film-coating slurries and separators were prepared and manufactured according to Preparation Examples 2 and 3, respectively.

However, in Comparative Examples 3 and 4, poly (vinyl acetate) and poly (methyl methacrylate) were used instead of copolymers, respectively.

TABLE 1

| | Copolymer monomer | | | TA (content |
|---|---|---|---|---|
| | (weight ratio) | | Hydrolysis | compared to entire |
| Classification | VA | MMA | rate (%) | copolymer) (wt %) |
| Example 1 | 75 | 25 | 90 | 0.2 |
| Example 2 | 60 | 40 | 90 | 0.2 |
| Example 3 | 75 | 25 | 80 | 0.2 |
| Example 4 | 75 | 25 | 95 | 0.2 |
| Example 5 | 75 | 25 | 90 | 0.4 |
| Comparative | 90 | 10 | 90 | 0.2 |
| Example 1 | | | | |
| Comparative | 50 | 50 | 90 | 0.2 |
| Example 2 | | | | |
| Comparative | 100 | 0 | 90 | 0.2 |
| Example 3 | | | | |
| Comparative | 0 | 100 | 90 | 0.2 |
| Example 4 | | | | |
| Comparative | 75 | 25 | 65 | 0.2 |
| Example 5 | | | | |
| Comparative | 75 | 25 | 90 | 0 |
| Example 6 | | | | |
| Comparative | 75 | 25 | 90 | 1 |
| Example 7 | | | | |

### [Evaluation Example 1] Particle Diameter of Inorganic Particles in Porous Film-Coating Slurry

Using the binder copolymers of Examples 1 to 5 and Comparative Examples 1 to 7, 0.05 g of each porous film-coating slurry, prepared according to Preparation Example 2, was added to 30 g of distilled water and diluted. About 3 ml of the diluted pretreatment sample was injected into a particle size analyzer to analyze the particle size using dynamic light scattering.

### [Evaluation Example 2] Adhesive Strength of Porous Film-Coating Slurry

Using the binder copolymers of Examples 1 to 5 and Comparative Examples 1 to 7, each separator, manufactured according to Preparation Example 3, was cut to a size with a width of 18 mm and a length of 100 mm.

A double-sided tape having an area with a width of 20 mm and a length of 40 mm was attached to an acrylic plate having an area with a width of 40 mm and a length of 100 mm. Such a prepared separator was attached to the double-sided tape and then lightly pressed five times with a hand roller. The specimen prepared above was mounted on UTM (20 kgf load cell) so that one part of the separator was fixed to the upper clip of the tensile strength machine while fixing the bottom part of the tape, attached to one side of the separator, onto the lower clip to measure 180° peel strength at a speed of 100 mm/min. The average value thereof was calculated through measurement performed on five or more specimens prepared per sample.

### [Evaluation Example 3] Heat Shrinkage Rate of Separator

Using the binder copolymers of Examples 1 to 5 and Comparative Examples 1 to 7, each separator, manufactured according to Preparation Example 3, was cut to prepare specimens having a width of 5 cm and a length of 100 mm. These specimens were left in an oven at a temperature of 150° C. for 1 hour, and then the shrinkage rate was measured.

The measurement results for the binder copolymers, the porous film-coating slurries, and the separators, measured by Evaluation Examples 1 to 3, are shown in Table 2 below.

TABLE 2

| | Median particle size of | Adhesive | Heat shrinkage |
|---|---|---|---|
| | inorganic particles in | strength | rate (%) |
| Classification | slurry composition (nm) | (gf/mm) | [MD/TD] |
| Example 1 | 735 | 93 | 4.5/5 |
| Example 2 | 747 | 116 | 4/5 |
| Example 3 | 766 | 110 | 3.5/5 |
| Example 4 | 730 | 88 | 3/5 |
| Example 5 | 722 | 100 | 3.5/4.5 |
| Comparative | 753 | 110 | 4/4 |
| Example 1 | | | |
| Comparative | 858 | 132 | 3.5/5.5 |
| Example 2 | | | |
| Comparative | 768 | 122 | 7/8 |
| Example 3 | | | |
| Comparative | 756 | 76 | 20/21 |
| Example 4 | | | |
| Comparative | 808 | 128 | 7/9 |
| Example 5 | | | |
| Comparative | 764 | 83 | 5/6.5 |
| Example 6 | | | |
| Comparative | 721 | 95 | 5/5.5 |
| Example 7 | | | |

First, from the measurement results for the median particle size of the inorganic particles in the slurry composition, in the case of Comparative Examples 1 to 4, where the conditions, other than the weight ratio of VA to MMA that did not fall within the range (VA:MMA=1.5:1 to 3:1), were the same as those of Examples 1 and 2, the median particle size of the inorganic particles in each slurry composition was larger than that in the case of Examples 1 and 2, confirming that the dispersion stability was poor.

In particular, in the case of Comparative Examples 2 to 4, the heat shrinkage rate in at least one of the MD and TD directions exceeded 5%, confirming that the heat resistance was poor.

Additionally, in the case of Comparative Example 5, where the hydrolysis rate was lower than that in the case of Examples 1, 3, and 4, the median particle size of the inorganic particles in the slurry composition was large, confirming that the dispersion stability was poor.

In particular, in the case of Comparative Example 5, the heat shrinkage rates in both the MD and TD directions exceeded 5%, confirming that the heat resistance of the separator was poor.

In other words, the weight ratio of VA to MMA and the hydrolysis rate were confirmed to affect the dispersion stability of the slurry composition and the heat resistance of the separator.

On the other hand, when comparing Examples 1 and 5 and Comparative Examples 6 and 7 that differed only in TA content, in the case of Comparative Example 6, not containing TA, the median particle size of the inorganic particles in the slurry composition was larger than that in the case Examples 1 and 5, leading to a deterioration in dispersion stability.

In the case of Comparative Example 7, where the TA content was higher than that in the case of Examples 1 and 5, the median particle size of the inorganic particles in the slurry composition was small, confirming that the dispersion stability was poor. However, in terms of heat shrinkage rate, the heat shrinkage rate in the TD direction of the separator was increased to 5.5, confirming that the heat resistance of the separator was poor.

In other words, the TA content was confirmed to affect the dispersion stability of the slurry composition and the heat resistance of the separator.

As a result, the copolymers corresponding to Examples 1 to 5 were confirmed to improve the dispersion stability of the slurry composition. Additionally, the slurry compositions and separators, using the copolymers of Examples 1 to 5, were confirmed to have balanced adhesive strength and heat resistance, compared to the slurry compositions and separators, using the copolymers of Comparative Examples 1 to 7.

The scope of the present disclosure is defined by the appended claims rather than the detailed description presented above. All changes or modifications derived from the meaning and scope of the claims and the concept of equivalents should be construed to fall within the scope of the present disclosure.

### INDUSTRIAL APPLICABILITY

A copolymer of the present disclosure is capable of improving the dispersion stability of a slurry composition, increasing adhesive strength to a polyolefin film, which is a separator substrate, and improving the heat resistance of a separator.

1. A copolymer comprising:
a vinyl acetate-based monomer unit in an amount of 3 wt % or greater and 38 wt % or less;
a vinyl alcohol-based monomer unit in an amount of 57 wt % or greater and 81 wt % or less
an acrylate-based monomer unit in an amount of 0.7 wt % or greater and 18 wt % or less;
an acrylic acid-based monomer unit in an amount of 14 wt % or greater and 38 wt % or less; and
an amine-based organic compound in an amount of less than 1 wt %, based on 100 wt % of the total weight of the copolymer.

2. The copolymer of claim 1, wherein the copolymer is represented by Formula 1, 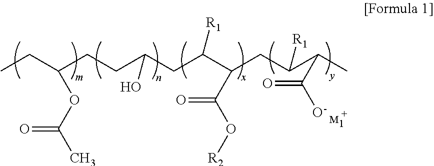
where in Formula 1, R₁ is hydrogen or a straight-chain or branched-chain hydrocarbon having 1 to 4 carbon atoms,
each R₂ is hydrogen or a straight-chain or branched-chain hydrocarbon having 1 to 20 carbon atoms,
M₁ comprises one or more selected from the group consisting of secondary and tertiary amines, and
m, n, x, and y satisfy m+n+x+y=1.

3. The copolymer of claim 2, wherein R₁ in Formula 1 comprises one or more selected from the group consisting of hydrogen, methyl, and ethyl, and
R₂ in Formula 1 comprises one or more selected from the group consisting of methyl, ethyl, n-propyl, isopropyl, n-butyl, tert-butyl, n-pentyl, n-hexyl, n-heptyl, n-octyl, 2-ethylhexyl, n-nonyl, n-decyl, n-undecyl, lauryl, n-dodecyl, n-tridecyl, n-tetradecyl, n-pentadecyl, cetyl, n-hexadecyl, n-heptadecyl, stearyl, n-octadecyl, n-nonadecyl, n-icosyl, n-henicosyl, n-docosyl, isopentyl, isoheptyl, isooctyl, isononyl, isodecyl, isoundecyl, isododecyl, isotridecyl, isotetradecyl, isopentadecyl, isocetyl, isohexadecyl, isoheptadecyl, isostearyl, isooctadecyl, isononadecyl, isoicosyl, isohenicosyl, and isodocosyl.

4. The copolymer of claim 2, wherein M₁ in Formula 1 comprises one or more selected from the group consisting of compounds of Formulas 2 to 5, 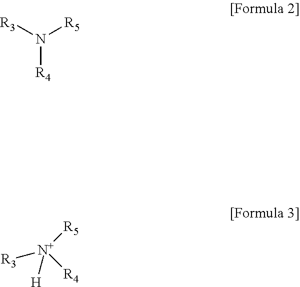
where in Formulas 2 and 3, R₃ to R₅ are each independently a straight-chain or branched-chain hydrocarbon having 1 to 6 carbon atoms, 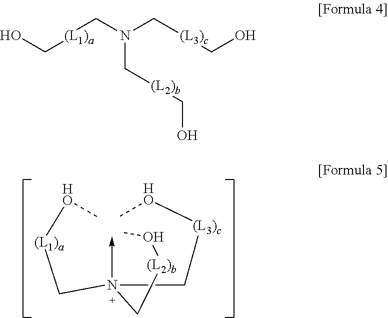
where in Formulas 4 and 5, L₁ to L₃ are each independently an alkylene group having 1 to 6 carbon atoms, and
a to c are each independently an integer of 0 to 2.

5. The copolymer of claim 1, wherein the copolymer is a random or block copolymer.

6. The copolymer of claim 1, wherein the copolymer has a number average molecular weight in a range of 5,000 to 1,000,000.

7. The copolymer of claim 2, wherein m, n, x, and y in Formula 1 satisfy the following expressions:
1.5≤(m+n)/(x+y)≤5.5,
0.05≤m/n≤0.45, and
0.05≤x/y≤0.45.

8. A slurry composition comprising:
the copolymer of claim 1; and
inorganic particles.

9. A separator comprising the slurry composition of claim 8.

10. (canceled)
